(19) United States
(12) Patent Application Publication
(10) Pub. No.: US 2001/0054007 A1
(43) Pub. Date: Dec. 20, 2001

(54) Intermediation control apparatus and computer-readable storage medium storing intermediation control program

(76) Inventors: Tetsuo Minakawa, Aomori (JP); Hitoshi Takeuchi, Aomori (JP); Makoto Hatta, Aomori (JP)

Correspondence Address: STAAS & HALSEY, 700 Eleventh Street, N.W., Suite 500, Washington, DC, 20001, US

(21) Appl. No.: 09/764,160

(22) Filed: Jan. 19, 2001

(30) Foreign Application Priority Data
Jun. 15, 2000 (JP) 2000-179293

(51) Int. Cl. G06F 17/60

(52) U.S. Cl. 705/26

(57) ABSTRACT

There is provided an intermediation control apparatus that carries out intermediation control while securing reliability of the system by protection of information. An extraction section (disclosure information-extracting section) determines a range of personal information of a user, for disclosure, based on a kind of request information sent from the user, and extracts the range of personal information from the personal information. A transaction section (disclosure information-extracting section) makes the extracted range of personal information and contents of a request available to the service provider.

### BACKGROUND OF THE INVENTION

1. Field of the Invention

This invention relates to an intermediation control apparatus and a computer-readable storage medium storing an intermediation control program, and more particularly to an intermediation control apparatus that carries out intermediation between users and a service provider via a network, and a computer-readable storage medium storing an intermediation control program that causes a computer to execute intermediation control.

2. Description of the Related Art

Recently, with the widespread use of the Internet, an online intermediary business industry is developing. The online intermediary business is a network business in which an intermediary agent makes information of commercial products of companies available to the public online, and users purchase desired ones of the commercial products online by browsing the information.

An online insurance sales intermediary business is an example of the online intermediary business. According to the service provided by the online insurance sales intermediary business, an intermediary agent provides, by online service, a consumer who wishes to purchase an insurance, such as an automobile insurance, a life insurance, a fire insurance, or the like, with estimates of premiums of insurances offered by several most suitable insurance companies selected by the agent according to the user's desired conditions of purchase.

Then, the consumer interactively determines his own needs of insurance, i.e. how much insurance of which type is necessary to him, by answering questions provided by the online service, to purchase a desired insurance.

Thus, the online insurance sales intermediary business can invite customers to readily take part in a purchasing process provided online, and offers suppliers of commodity-type insurance products the merits of increased efficiency of a purchasing process, and reduced costs of marketing and distribution.

In the conventional online insurance sales intermediary business, personal information of each user is a key factor of sales, but conventionally, the personal information is not made secret enough to prevent a third party's use of the information. In an open network environment, such as the Internet, the security technology protecting the personal information is essential to realize a safe business transaction.

### SUMMARY OF THE INVENTION

The present invention has been made in view of the above circumstances, and an object thereof is to provide an intermediation control apparatus that carries out intermediation control while securing reliability of an online business by protecting the security of information used in the business.

Further, another object of the invention is to provide a computer-readable storage medium storing an intermediation control program that carries out intermediation control while securing reliability of an online business by protecting the security of information used in the business.

To attain the above object, the invention provides an intermediation control apparatus that carries out intermediation between a user and a service provider. The intermediation control apparatus comprises extraction means for determining a range of personal information of a user, for disclosure, based on a kind of request information sent from the user, and extracting the range of personal information from the personal information; and transaction means for making the extracted range of personal information and contents of a request available to the service provider.

The above and other objects, features and advantages of the present invention will become apparent from the following description when taken in conjunction with the accompanying drawings which illustrate a preferred embodiment of the present invention by way of example.

### BRIEF DESCRIPTION OF THE DRAWINGS

FIG. 1 is a diagram showing the principles of an information communication system;

FIG. 2 is a diagram showing the construction of a commodity sales system;

FIG. 3 is a diagram showing a personal data entry screen;

FIG. 4 is a diagram showing an estimate request data entry screen;

FIG. 5 is a disclosure information extraction table;

FIG. 6 is a diagram showing a proposal request retrieval screen;

FIG. 7 is a diagram showing a product proposal retrieval screen;

FIG. 8 is a diagram showing an insurance product guide screen;

FIG. 9 is a sequence diagram showing a sales process involving information of insurance products;

FIG. 10 is a sequence diagram showing a continued part of the sales process; and

FIG. 11 is a sequence diagram showing a continued part of the sales process.

### DESCRIPTION OF THE PREFERRED EMBODIMENT

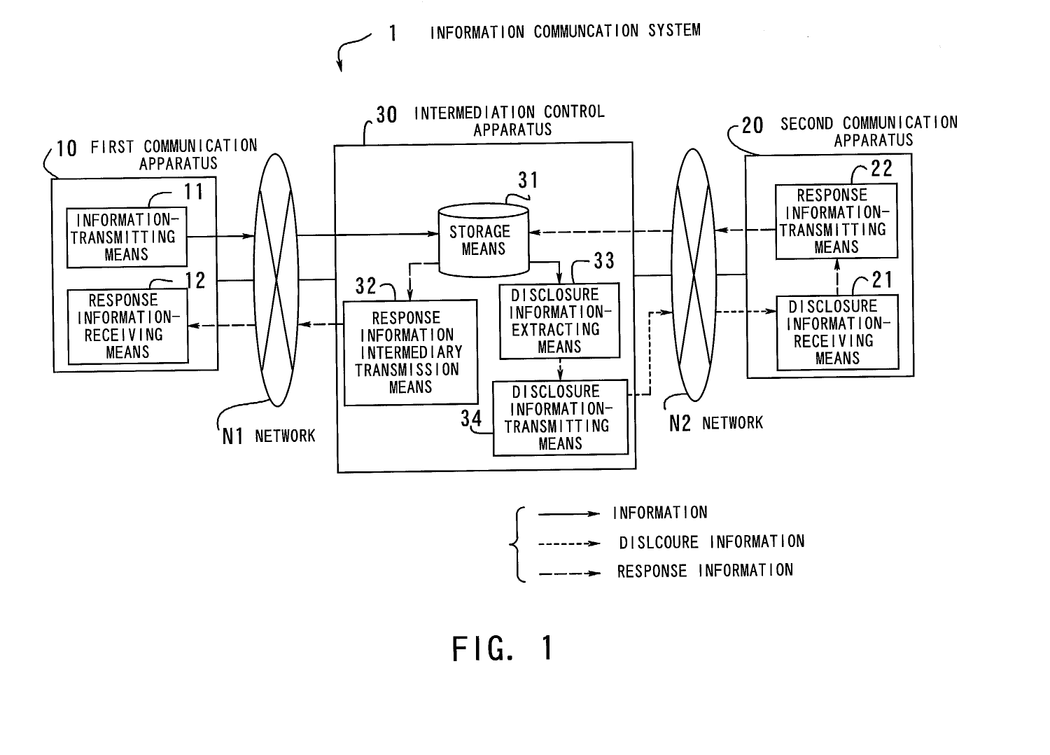

A preferred embodiment of the present invention will be described below with reference to accompanying drawings. FIG. 1 is a diagram showing the principles of an information communication system. The information communication system 1 includes an intermediation control apparatus 30, and a service providing apparatus (corresponding to a second communication apparatus 20).

In the intermediation control apparatus 30, extraction means (corresponding to disclosure information-extracting means 33) determines a range of personal information of a user, for disclosure, based on the kind (e.g. type of an insurance, such as a fire insurance or an earthquake insurance) of request information (e.g. information of a request of an estimate of a premium of an insurance) sent from the user, and extracts the range of personal information from the personal information.

Transaction means (corresponding to disclosure information-transmitting means 34) makes the extracted range of personal information and contents of a request available to a service provider (corresponding to the second communication apparatus 20). Storage means 31 stores personal information together with user IDs.

The extraction means is responsive to request information including a user ID for determining information for disclosure (hereinafter referred to as “disclosure information”) of personal information stored in the storage means 31 based on the user ID and the kind of request information.

Further, the transaction means 34 makes the extracted user's personal information and the contents of a request available on a site where the service provider is permitted to access through authentication (e.g. a Web site under management of the intermediation control apparatus 30; however, to access the site, the service provider is required to have his ID, password, and the like validated and authenticated.).

Further, the extraction means further includes a management table for managing correlation between kinds of request information and respective sets of items of disclosure information of personal information, and determines the items of disclosure information based on the management table.

It should be noted that hereinafter, the extraction means is referred to as the disclosure information-extracting means 33, and the transaction means as the disclosure information-transmitting means 34.

Next, the information communication system 1 which uses the intermediation control apparatus 30 will be described in further detail. The information communication system 1 is comprised of a first communication apparatus 10, a second communication apparatus 20, and the intermediation control apparatus 30. The first communication apparatus 10 and the intermediation control apparatus 30 are connected to each other by a network N1, and the intermediation control apparatus 30 and the second communication control system 20 are connected to each other by a network N2. It should be noted that actually, there are a plurality of equivalents of the first communication apparatus 10 and the second communication apparatus 20.

The first communication apparatus 10 includes information-transmitting means 11 for sending information to the intermediation control apparatus 30, and response information-receiving means 20 for receiving response information sent in response to the transmitted information.

The intermediation control apparatus 30 is comprised of the storage means 31, response information intermediary transmission means 32, the disclosure information-extracting means 33, and the disclosure information-transmitting means 34. The storage means 31 receives information sent from the first communication apparatus 10 and response information sent from the second communication apparatus 20, and stores the received information therein. The response information intermediary transmission means 32 carries out intermediary transmission of response information from the second communication apparatus 20 to the first communication apparatus 10.

The disclosure information-extracting means 33 automatically extracts disclosure information, which is permitted to be disclosed, from information received from the first communication apparatus 10. It should be noted that the disclosure information-extracting means 33 has a look-up table formed in advance such that kinds of request information and respective sets of items of disclosure information are correlated with each other. This makes it possible to efficiently extract the disclosure information from the request information.

The disclosure information-transmitting means 34 transmits the extracted disclosure information to the second communication apparatus 20.

The second communication apparatus 20 is comprised of disclosure information-receiving means 21 and response information-transmitting means 22. The disclosure information-receiving means 21 receives disclosure information sent from the intermediation control apparatus 30. The response information-transmitting means 22 transmits response information generated based on the disclosure information.

It should be noted that although in the above description, disclosure information is extracted from request information sent (entered) by the user, this is not limitative, but personal information of a user may be recorded in the intermediation control apparatus 30 in advance (e.g. by membership registration), whereby items of disclosure information may be determined from the kind of request information, and then contents of the items of disclosure information may be extracted from the recorded personal information based on the user ID contained in the request information.

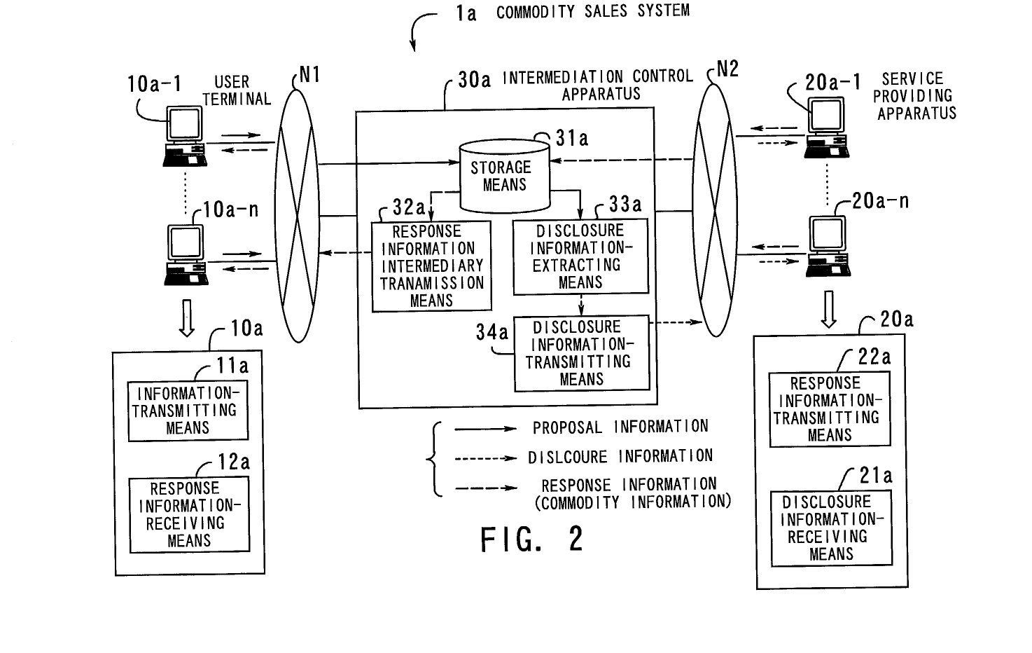

Next, a commodity sales system in which the information communication system 1 is applied to an online intermediary business will be described. FIG. 2 shows the configuration of the commodity sales system.

The commodity sales system 1a is comprised of user terminals 10a-1 to 10a-n (customer side), service providing apparatuses 20a-l to 20a-n (commodity-selling company side), and an intermediation control apparatus 30a (intermediary agent side). The user terminals 10a-1 to 10a-n and the intermediation control apparatus 30a are connected by the network N1, and the intermediation control apparatus 30a and the service providing apparatuses 20a-1 to 20a-n are connected by the network 2.

It should be noted that the user terminal 10a (referred to as the user terminal 10a when the user terminals are generically referred to), the service providing apparatus 20a (referred to as the service providing apparatus 20a when the service providing apparatuses are generically referred to), and the intermediation control apparatus 30a correspond to the first communication apparatus 10, the second communication apparatus 20, and the intermediation control apparatus 30, shown in FIG. 1, respectively.

Each user terminal 10a includes information-transmitting means 11a for transmitting request information concerning a commodity which a user wishes to purchase, and response information-receiving means 12a for receiving commodity information from the service providing apparatus 20a as response information in reply to the request information sent from the information-transmitting means 11a.

Conventionally, a company makes commodity information available to the public, while a user purchases a desired commodity by browsing the commodity information. In contrast, according to the commodity sales system 1a of the invention, a user proposes a commodity which he wishes to purchase, and the intermediary agent discloses the information to a plurality of companies. Thereafter, companies make access to the user.

It should be noted that the OS (Operating System) of the user terminal 10a provides the user with user interface screens required in carrying out operations for preparation of request information and display of the request information, as well as display of response information responding to the request information.

The intermediation control apparatus 30a is comprised of the storage means 31a, response information intermediary transmission means 32a, disclosure information-extracting means 33a, and disclosure information-transmitting means 34a. The storage means 31a receives request information sent from the user terminal 10a and response information sent from the service providing apparatus 20a, and stores the received information therein. The response information intermediary transmission means 32a carries out intermediary transmission of response information from the service providing apparatus 20a to the user terminal 10a.

The disclosure information-extracting means 33a automatically extracts disclosure information, which is permitted to be disclosed, from the request information received from the user terminal 10a. The request information sent by the user can contain personal data concerning the user. Therefore, items of the personal data, which are permitted to be disclosed, are extracted as the disclosure information.

It should be noted that the disclosure information-extracting means 33a has a look-up table formed in advance such that kinds of request information and respective sets of items of disclosure information are correlated with each other. This makes it possible to efficiently extract the disclosure information from the request information. The disclosure information-transmitting means 34a transmits the extracted disclosure information to the service providing apparatus 20a. The method of transmission may be disclosed on a Web site while requiring authentication by password.

The service providing apparatus 20a is comprised of disclosure information-receiving means 21a, and response information-transmitting means 22a. The response information-receiving means 21a receives disclosure information sent from the intermediation control apparatus 30a. The response information-transmitting means 22a transmits response information generated based on the disclosure information to the intermediation control apparatus 30a. In other words, the service provider creates commodity information, such as electronic files of a pamphlet and an written estimate, and sends the commodity information as the response information in reply to the request information.

It should be noted that the OS (Operating System) of the service providing apparatus 20a provides the service provider with user interface screens required in carrying out operations for display of request information as well as creation and display of response information.

As described above, the commodity sales system 1a according to the invention is configured such that the intermediation control apparatus 30a automatically extracts a portion permitted to be disclosed (disclosure information) from request information proposed by a user, and sends the extracted disclosure information to the service providing apparatus 20a. This makes it possible to carry out communication concerning commodity sales while protecting personal data, and thereby attain an enhanced reliability of the system.

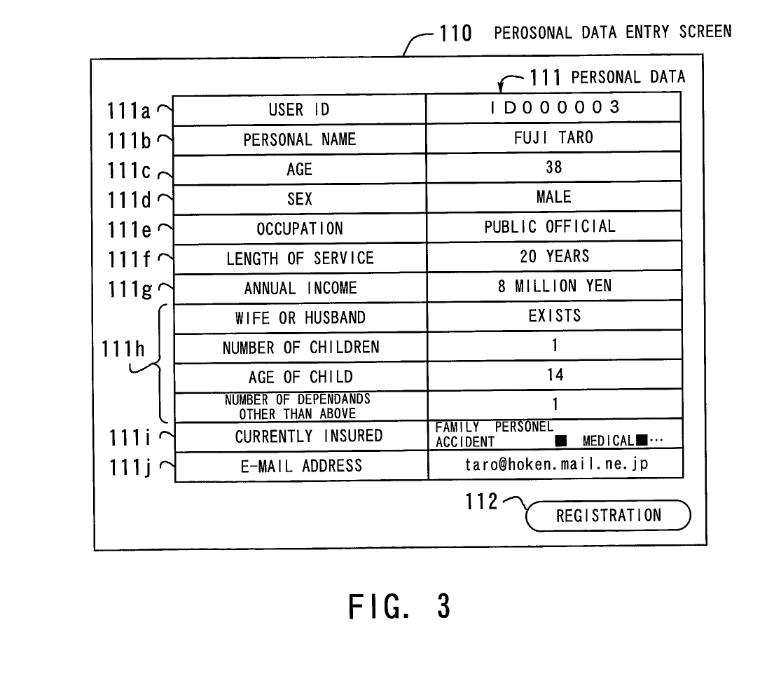

Next, a commodity sales system 1a dealing with insurance product information will be described by way of example. FIG. 3 shows a personal data entry screen 110, which is displayed on the user terminal 10a.

A user enters a user ID, a password an the like to obtain authenticated approval to access to the commodity sales system 1a, and then makes a proposal concerning an insurance product which he wishes to purchase. First, the user sequentially enters personal data as to items presented in the personal data entry screen 110.

In proposal elements concerning an insurance product, personal data 111 has a key importance. Therefore, maintenance of the personal data is carried out by using the personal data entry screen 110.

Out of the entry items, “user ID” 111a cannot be changed and one recorded in advance is automatically displayed; “personal name” 111b cannot be changed and one recorded in advance is automatically displayed; “age” 111c cannot be changed and one automatically calculated from a date of birth recorded in advance is automatically displayed; and “sex” cannot be changed and one recorded in advance is automatically displayed.

Further, as to the items of “occupation” 111e, “length of service” 111f, “annual income” 111g, “family make-up” 111h (“wife or husband”, “number of children”, “age of a child”, “dependant other than the above”), “insurance currently taken up” 111i, and “email address” 111j, necessary data are entered.

Then, by depressing a registration button 112, the information-transmitting means 111a transmits the entered personal data 111a.

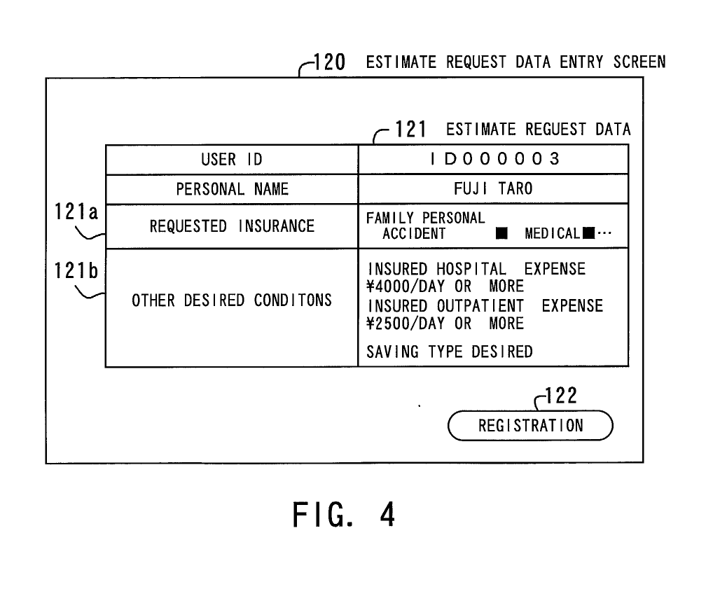

FIG. 4 shows a request data entry screen 120, which is displayed on the user terminal 10a when a user creates estimate request data 121 requesting information of an estimate concerning an insurance product which the user wishes to purchase.

Out of the entry items, “user ID” cannot be changed and one recorded in advance is automatically displayed; and “name” cannot be changed and one recorded in advance is automatically displayed. Further, the user enters the name of an insurance which he wishes to purchase to “requested insurance” 121a, and detailed proposal to “other desired conditions” 121b.

Then, by depressing an registration button 122, the entered estimate request data 121 is sent by the information-transmitting means 11a. It should be noted that a combination of personal data 111 and estimate request data 121 forms request information.

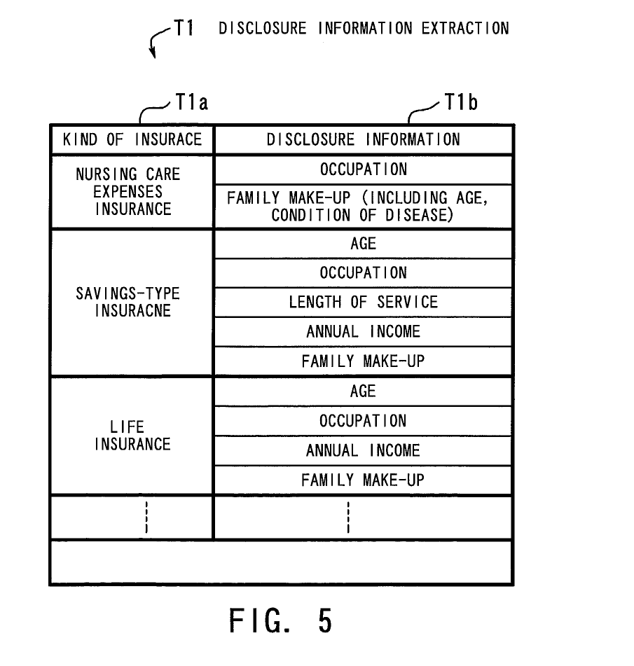

Next, the disclosure information-extracting means 33a will be described. FIG. 5 shows a disclosure information extraction table T1. The disclosure information table T1 defines correlations between kinds of request information and respective sets of items of disclosure information of the request information, which are permitted to be disclosed, and is managed by the disclosure information-extracting means 33a.

The disclosure information extraction table T1 includes a column of types of insurance T1a, and a column of items of disclosure information T1b. In the illustrated example, in response to an estimate request concerning a nursing care expenses insurance by a user, items of information which are permitted to be disclosed to insurance companies are an occupation, and a family make-up (including an age, and a condition of the disease).

Therefore, if an insurance 121a requested by the estimate request data 121 is a nursing care expenses insurance, the disclosure information-extracting means 33a extracts information of the occupation 111e and family make-up 111h, from the personal data 111.

Further, in response to an estimate request concerning a savings-type insurance by a user, items of information which are permitted to be disclosed to the insurance companies are an age, an occupation, length of service, an annual income, and a family make-up.

Therefore, if an insurance 121a requested by the estimate request data 121 is a savings-type insurance, the disclosure information-extracting means 33a extracts information of the age 111c, the occupation 111e, the length of service 111f, the annual income 111g, and the family make-up 111h, from the personal data 111.

Further, as for an estimate request concerning a life insurance by a user, items of information which are permitted to be disclosed to the insurance companies are an age, an occupation, an annual income, and a family make-up.

Therefore, if an insurance 121a requested by the estimate request data 121 is a life insurance, the disclosure information-extracting means 33a extracts information of the age 111c, the occupation 111e, the annual income 111g, and the family make-up the 111h, from the personal data 111.

Thus, each set of items of information permitted to be disclosed is tabulated in a manner indexed by a corresponding kind of insurance, whereby it is possible to efficiently extract disclosure information.

It should be noted that although the disclosure information extraction table T1 shown in FIG. 5 contains the nursing care expenses insurance, the savings-type insurance, and the life insurance, this is not limitative, but disclosure information can be set to desired kinds of insurance, including a fire insurance, an earthquake insurance, and an automobile insurance, in addition to the above illustrated insurances.

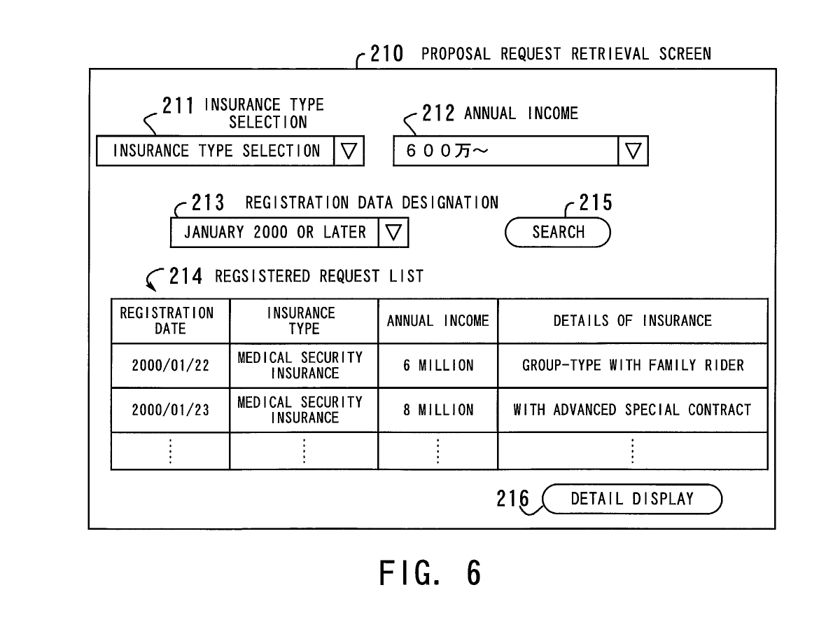

Next, a proposal request retrieval screen displayed on the service providing apparatus 20a of an insurance company will be described. FIG. 6 shows a proposal request retrieval screen 210. Insurance companies can be informed of proposal requests of insurance products made by users, by using the proposal request retrieval screen 210.

The proposal request retrieval screen displays entry boxes for an insurance type selection 211, an annual income 212, and registration data designation 213, as well as a registered request list 214, a search button 215, and a details display button 216.

Input to the entry box of the insurance type selection 211 is a type of insurance which a service provider wishes to select. Input to the entry box of the annual income 212 is an amount of annual income which the service provider wished to select. Input to the entry box of registration data designation 213 is a date of registration which the service provider wishes to select.

After inputting data to the entry boxes of the insurance type selection 211, the annual income 212, and the registration data designation 213, if the search button 215 is depressed, the registered request list 214 is displayed, whereby the service provider can know of proposal requests corresponding to the entered data.

For instance, after the service provider inputs “medical security insurance” to the entry box of insurance type selection 211, “6 million or more” to that of the annual income 212, and “January 2000, or later” to that of the registration date designation, if the search button 215 is depressed, data as in the illustrated example are displayed in the registered request list 214.

Further, if the service provider wishes to know further details of information of a proposal request in a row of the registered request list, after pointing within the row by a mouse or the like, by depressing the details display button 216, the disclosure information corresponding to the row is displayed (not shown).

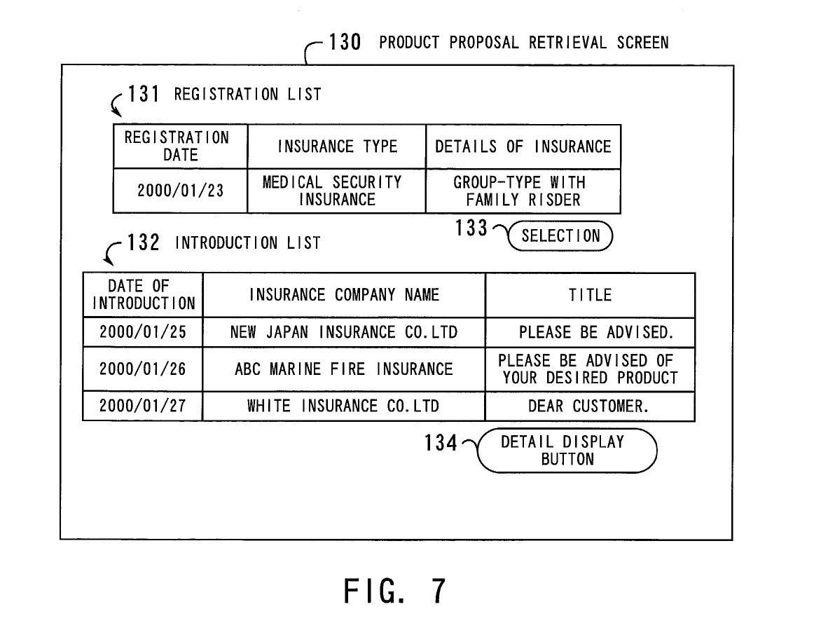

Next, a product proposal retrieval screen will be described. FIG. 7 shows the product proposal retrieval screen 130, which is displayed on the user terminal 10a, to show responses of insurance companies made in reply to a proposal concerning an insurance product which the user wishes to purchase.

The product proposal retrieval screen 130 displays a registration list 131, an introduction list 132, a selection button 133, and a details display button 134.

The registration list 131 shows an insurance product registered (proposed) by the user. If the user wishes to know further details of information of an insurance product in a row of the registration list 131, after pointing within the row of the registration list 131 by a mouse or the like, by depressing the selection button 133, the responses from insurance companies corresponding to the insurance product of the pointed row are displayed in the introduction list 132.

Then, If the user wishes to know further details of information offered by an insurance company in a row of the introduction list 132, after pointing within the row of the introduction list 132 by a mouse or the like, by depressing the details display button 134, further details of the information, i.e. introduction to an insurance product offered by the insurance company corresponding to the pointed row within the introduction list 132 are displayed (this display screen will be described hereinafter).

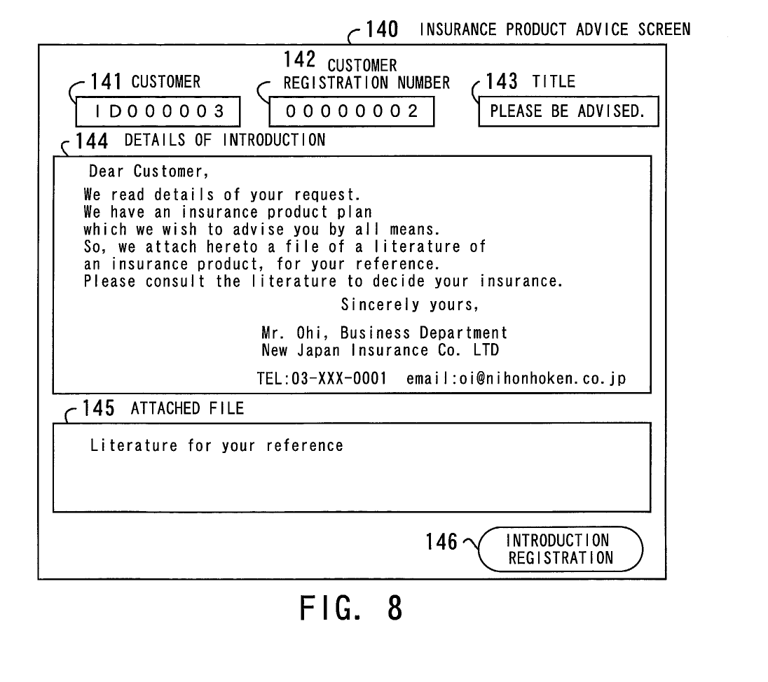

Next, an insurance product advice screen will be described. FIG. 8 shows the insurance product advice screen. A person in charge in an insurance company (service provider) creates insurance product information similar to a commodity advice leaflet based on the information obtained from the proposal request retrieval screen 210 and the disclosure information.

The insurance product information is response information prepared in response to the request information, and sent from the service providing apparatus 20a via the intermediation control apparatus 30a to the user terminal 10a. Then, when the details display button 134 in the FIG. 7 product proposal retrieval screen 130 is depressed, the insurance product information is displayed on the insurance product advice screen 140.

The insurance product advice screen 140 displays a customer 141, a customer registration number 142, a title 143, details of introduction 144, an attached file 145, and a customer registration button 146.

The customer 141 shows an ID number of a user to whom an insurance product is to be introduced or advised. The customer registration number 142 shows a registration number of the user managed by an insurance company. The title 143 shows a title of introduction to the insurance product. The details of introduction 144 show details of the introduction to the insurance product. The attached file 145 shows a file of a further detailed introduction to the product.

Further, if the user wishes to know further details of contents displayed on the screen, or have a question, he depresses the introduction registration button 146, and thereafter negotiation is carried out between the user and the insurance company.

It should be noted that the services shown in FIGS. 1 and 2, are provided on a Web site managed by the intermediation control apparatus 30, and the screens shown in FIGS. 3, 4 and 6 to 8 correspond to respective forms provided by the Web site, and are sent in response to respective requests made by a user or a service provider.

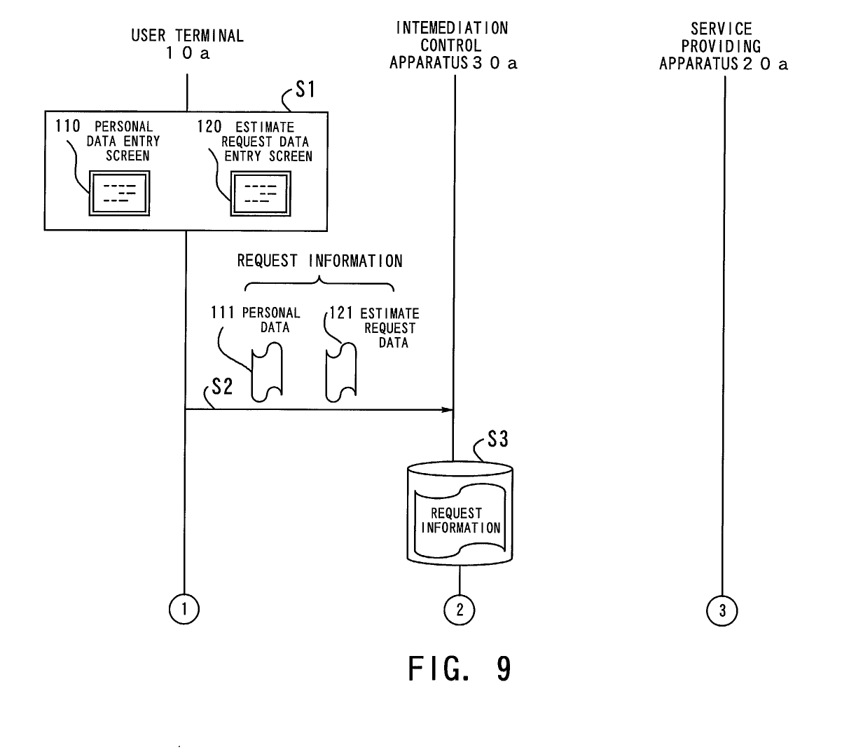

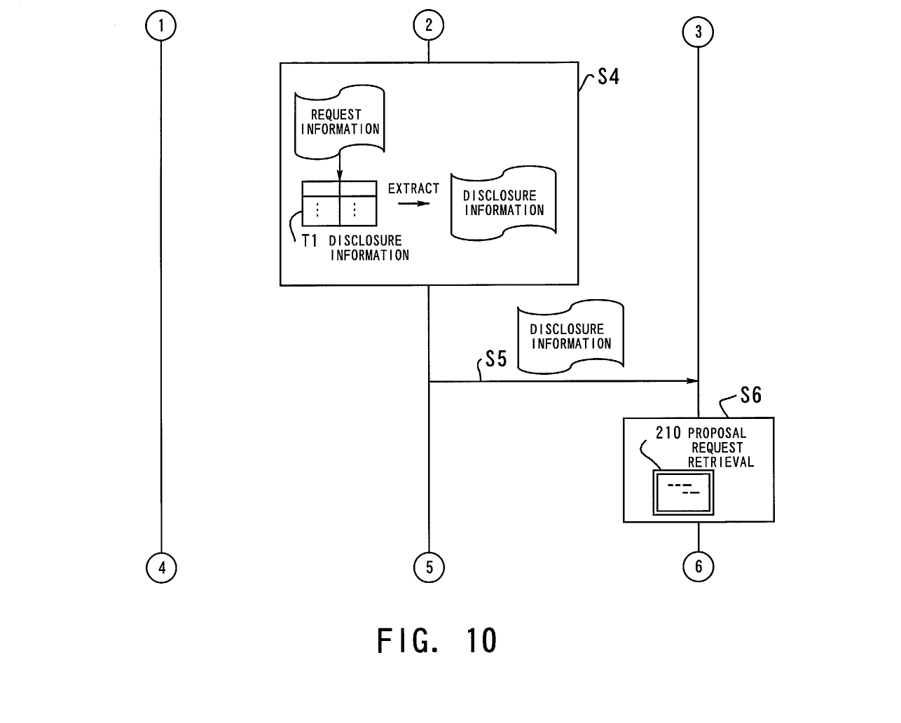

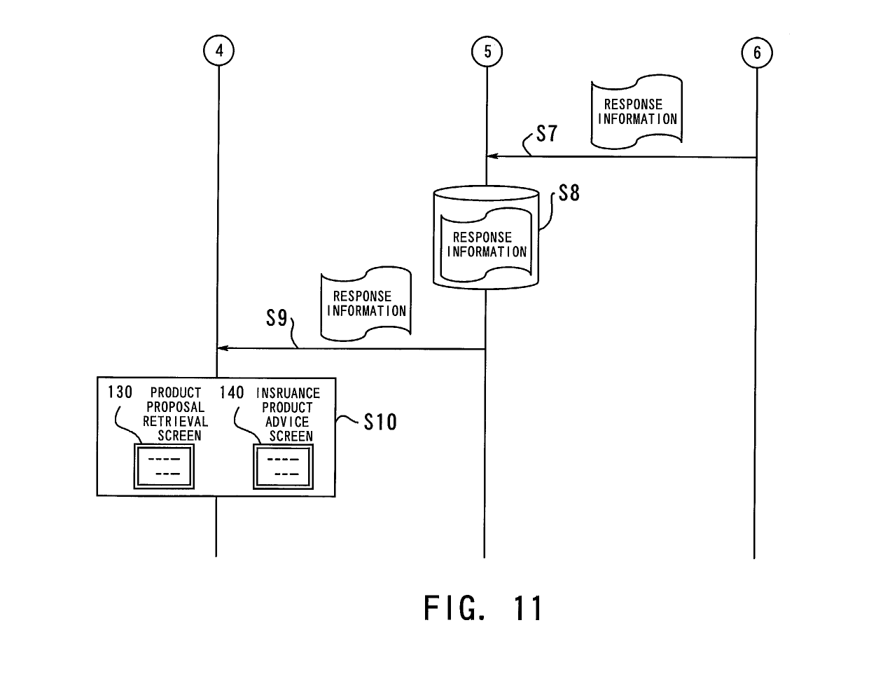

Next, a sales process carried out based on insurance product information by the commodity sales system 1a will be described with reference to a sequence diagram shown in FIGS. 9 to 11.

[S1] A user enters data into the personal data entry screen 110 (FIG. 3) and the estimate request data entry screen 120 (FIG. 4) by means of the user terminal 10a.

[S2] The information-transmitting means 11a transmits request information comprised of the personal data 111 and the estimate request data 121 to the intermediation control apparatus 30a.

[S3] The storage means 31a receives the request information and stores the same therein.

[S4] The disclosure information-extracting means 33a extracts disclosure information from the request information stored therein by using the disclosure information extraction table T1 (FIG. 5).

[S5] The disclosure information-transmitting means 34a transmits the disclosure information including the estimate request data to the service providing apparatus 20a, which receives the disclosure information including the estimate request data.

[S6] The service providing apparatus 20a displays the proposal request retrieval screen 210 (FIG. 6) based on the disclosure information including the estimate request data.

[S7] The response information-transmitting means 21 transmits the insurance product information as the response information created by the service provider to the intermediation control apparatus 30a.

[S8] The storage means 31a receives the response information and stores the same therein.

[S9] The response information intermediary transmission means 32a sends the response information to the user terminal 10a, and the user terminal 10a receives the response information.

[S10] The user terminal 10a displays the product proposal retrieval screen 130 (FIG. 7), and the insurance product advice screen 140 (FIG. 8). Thereafter, negotiation is carried out between the user and the insurance company.

As described heretofore, the commodity sales system 1a according to the invention is configured such that the intermediation control apparatus 30a extracts disclosure information permitted to be disclosed from the request information, and sends the disclosure information to the service providing apparatus 20a, and the service providing apparatus 20a creates response information based on the disclosure information and sends the response information to the user terminal 10a.

This makes it possible to carry out communication required in commodity sales, while protecting personal data, and hence the reliability of the system can be enhanced. Further, companies can efficiently select and evaluate purchasers, whereby contact can be made to only customers meeting conditions of a contract without wasting time for customers not meeting the conditions, which makes it possible to efficiently carry out the task.

Further, a computer program for realizing the above-described functions of the intermediation control apparatus 30 can be written in storage media, such as semiconductor storage devices and magnetic recording media.

This makes it possible to distribute the program to the market, by storing the program in portable recording media such as CD-ROMs (Compact Disk Read Only Memories) or floppy disks. Alternatively, the program may be stored in a storage device of a computer connected to a network and may be transferred to other computers through the network.

To execute the program by a computer, the program stored in a hard disk unit or the like of the computer is loaded into a main memory and executed.

Although in the above description, the commodity sales system 1a is applied to the online insurance sales intermediary business by way of example, but this is not limitative, but the invention can be applied to various online businesses.

Further, in the above description, the response information is transmitted from the service provider via the intermediation control apparatus 30 to the user, this is not limitative, but the response information may be directly sent from the service provider to the user. For instance, the whole system may be configured such that the intermediation control apparatus 30 extracts an E-mail address of a user as personal information, and supplies the E-mail address to the service provider, and the service provider transmits the response information directly to the user by using the E-mail address.

As described heretofore, the intermediation control apparatus according to the invention is configured to determine a range of personal information of a user, for disclosure, based on a kind of request information sent from the user and extract the range of personal information, and make the extracted range of personal information and contents of a request available to a service provider.

Further, the computer-readable recording medium according to the invention stores an intermediation control program that determines a range of personal information of a user, for disclosure, based on a kind of request information sent from the user, and extracts the range of personal information, and makes the extracted range of personal information and contents of a request available to a service provider.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. An intermediation control apparatus that carries out intermediation between a user and a service provider, the intermediation control apparatus comprising:
extraction means for determining a range of personal information of a user, for disclosure, based on a kind of request information sent from said user, and extracting said range of personal information from said personal information; and
transaction means for making said extracted range of personal information and contents of a request available to said service provider.

2. An intermediation control apparatus according to claim 1, further including memory means for storing said personal information together with a user ID of said user.

3. An intermediation control apparatus according to claim 2, wherein said extraction means is responsive to said request information including said user ID, for determining disclosure information of said personal information stored in said storage means based on said user ID and said kind of said request information, and extracting said disclosure information from said personal information,.

4. An intermediation control apparatus according to claim 1, wherein said transaction means makes said extracted range of personal information and said contents of said request available to said service provider on a site where said service provider is permitted to access through authentication.

5. An intermediation control apparatus according to claim 1, further including a management table for managing correlation between said contents of said request and disclosure information of said personal information.

6. An intermediation control apparatus according to claim 5, wherein said extraction means determines said disclosure information based on said management table.

7. An intermediation control apparatus according to claim 1, wherein said extraction means determines said range of personal information of said user, for disclosure, based on an estimate request of an insurance and a type of said insurance, as said request information sent from said user, and extracts said range of personal information from said personal information.

8. A service providing apparatus connected to a network, comprising:
disclosure information-receiving means for receiving disclosure information as a portion of request information received from a user, said portion being permitted to be disclosed; and
response information-transmitting means for transmitting commodity information created based on said disclosure information, as response information.

9. A service providing apparatus according to claim 8, wherein said disclosure information-receiving means receives, as said request information sent from said user, disclosure information which is a portion of a request of an estimate of an insurance, said portion being permitted to be disclosed.

10. A computer-readable recording medium which stores an intermediation control program for causing a computer to execute intermediation control, said intermediation control program causing said computer to function as:
extraction means for determining a range of personal information of a user, for disclosure, based on a kind of request information sent from said user, and extracting said range of personal information from said personal information; and
transaction means for making said extracted range of personal information and contents of a request available to said service provider.
